(19) United States
(12) Patent Application Publication
(10) Pub. No.: US 2021/0402226 A1
(43) Pub. Date: Dec. 30, 2021

(54) MASK/RESPIRATOR WITH MICROPHONE

(71) Applicant: Daniel Shear, West Hartford, CT (US)

(72) Inventor: Daniel Shear, West Hartford, CT (US)

(21) Appl. No.: 17/354,980

(22) Filed: Jun. 22, 2021

Related U.S. Application Data
(60) Provisional application No. 63/043,441, filed on Jun. 24, 2020.

(51) Int. Cl. A62B 18/08; A62B 18/02; H04R 1/08; G10L 15/26

(52) U.S. Cl. CPC A62B 18/08; A62B 18/025; A62B 23/02; G10L 15/26; H04R 1/08

(57) ABSTRACT

A mask or respirator that fits over a user's mouth and nose, comprising a material that covers the user's nose and mouth, and a means to incorporate wired microphones, wireless microphones, and other devices.

### CROSS-REFERENCE TO RELEATED APPLICATIONS

Reference is made to and priority claimed from U.S. Provisional Application Ser. No. 63043441, filed Jun. 24, 2020, entitled “Mask/Respirator with Microphone”

### FIELD OF THE INVENTION

The present invention relates to a mask, and more particularly to a mask having a system for attaching or holding a microphone.

### BACKGROUND OF THE INVENTION

Vast numbers of people are now wearing masks both in their day to day lives and at work. Mask use in the medical environment has also greatly increased. This has resulted in difficulty in communicating with others when the mask is in place over the wearer's nose and mouth. Often in an effort to communicate the mask wearer would pull their mask down to enhance communication when they talked, thus defeating the safety benefit of wearing a mask. When they left the mask in place they were often not understood or heard at all.

In the medical environment additional problems with communication exists. A sick patient may not be able to or even have the energy to speak loudly. Even if they were able to do so, they are often in a noisy environment which further adds to the difficulty in being heard. Pulling down their mask to speak greatly increases their exposure to germs and viruses as well as exposing others around them. Clear communication in the medical environment is critical and could be life threating if a need is not heard or if a patient's or doctor's communication is misunderstood due to the difficulty in communicating while wearing a mask.

However, adding a wired microphone to a mask or respirator presents many challenges. The microphone needs to be secure so that it is in the proper location for good communication. Wires from the microphone need to enter or exit the mask or respirator. Further the microphone must be secured in a manner to prevent problems with it interfering with communication from the wearer. Currently masks and respirators do not have a good way to deal with the wire from a wired microphone.

Adding a wireless microphone also has many issues that need to be addressed. Wireless microphones are often larger and heavier and need to be charged often. Their benefit is not having to deal with the microphone wire. An ideal mask system for attaching or holding a microphone would need to be able to deal with either or both types of microphones.

As another example, in many cases the masks and respirators need to be discarded or sterilized after each use. Some masks are not disposable and sterilizing them is a difficult task both in time and effort. Disposable masks and respirators and not made to attach or hold a microphone.

### SUMMARY OF THE INVENTION

Accordingly, it is the object of the present invention to add a microphone to the mask or respirator, in a manner that keeps the microphone in a secure and proper location while allowing good communication from the wearer and not interfere with either the wearer's communication or the wearer's safety or comfort.

It is another object of the present invention to allow microphone use with both disposable and non disposal non-disposable masks and respirators.

It is yet another object of the present invention to allow use with microphones that are disposal as well as microphones that are reusable. The way the microphone is attached or held in place to the masks and respirators will allow for easy removal of the microphones if so desired.

It is still a further object of the present invention to allow many different types of microphones to be used as well. Both wired and wireless microphones can be used. Wired and wireless microphones used in a mask or respirator each have their own advantages. An advantage of wired microphones is that they do not have to be charged so they would always be working, and they are generally smaller and lighter than the wireless microphones. Another advantage of wired microphones is that they can be less expensive than wireless microphones. The wired microphone's low cost can be very beneficial when large numbers of masks and respirators are outfitted with microphones, or when the mask's or respirator's user wishes to dispose of the microphone after it has been used. While the advantages of wireless microphones include no wires to deal with and the possibility of reaching a listener or signal processor for the microphone's signal that is further away. Wireless microphones also directly allow for the possibility of multiple listeners to hear the same signal even in different locations at the same time.

In another embodiment of the invention would allow for processing the signal from the microphone into a useable audio signal or converted to text or both. Further the audio or text or both can be sent to one or many recipients.

Briefly, a preferred embodiment of the present invention includes a mask or respirator which would accommodate both wired and wireless microphones or devices. Further the invention insures that the mask or respirator would remain sealed against the user's face when used with a wired microphone, wireless microphone or other device.

Additionally another benefit of the present invention is that it would allow other kind of wires, tubes, and other medical devices to enter or exit the mask or respirator without disturbing the mask's or respirator's seal on the wearer's face.

### BRIEF DESCRIPTIONS OF THE DRAWINGS

FIG. 1 shows a front view of a mask with a means to attach a microphone or device.

FIG. 2 shows a rear view of a mask with a pouch that can be opened for insertion and removal of a microphone or device. Pouch is shown in the closed position.

FIG. 3 shows the mask and pouch seen in FIG. 2 with the pouch in the open position.

FIG. 4 shows a rear view of a mask with another means to contain the microphone or device using a pouch with a flap.

FIG. 5 shows the mask and pouch in FIG. 4 in the open position.

FIG. 6 shows a rear view of a mask with a pouch that uses fingers to secure the microphone or device.

FIG. 7 shows the pouch using fingers in the open position.

FIG. 8 shows a rear view of yet another embodiment using one or more filaments as the means of securing a microphone or device.

FIG. 9 shows the embodiment in FIG. 8 in the secured position.

FIG. 10 shows a means of securing a microphone where the pouch uses two pieces of material that stick together when in contact with each other to secure the pouch to the mask.

FIG. 11 shows the embodiment in FIG. 10 in the attached position.

FIG. 12 shows many but not all of the possible positions for any of the pouches or attachment devices to be placed on the mask.

FIG. 13 shows a rear view of another possible means to secure a microphone or device in the mask using a loop attached to the mask or respirator.

FIG. 14 shows the embodiment in FIG. 13 in the secured position.

FIG. 15 shows a means of securing a microphone directly to the mask by means of two pieces of material that stick together when in contact with each other.

FIG. 16 shows a rear view of a means of securing a microphone to the mask using a hole in one or more layers in the mask.

FIG. 17 shows a side view of the embodiment in FIG. 16.

FIG. 18 shows a rear view of a means of securing a microphone or device using two strips of material where one strip includes a fastening mechanism and one strip is inserted into said fastening mechanism.

FIG. 19 shows the embodiment in FIG. 18 in the secured position.

FIG. 20 shows a rear view of a means of securing a microphone or device using placement in a vent on the mask.

FIG. 21 shows a front view of the embodiment in FIG. 20.

FIG. 22 shows a rear view of yet another embodiment where the microphone or device is placed in the vent secured by one or more filaments or elastic means.

FIG. 23 shows a front view of possible placement of a microphone or device in a respirator.

FIG. 24 shows a rear view of the embodiment in FIG. 23.

FIG. 25 shows a rear view of the mask or respirator edge loops.

FIG. 26 shows a close up view of the edge loops.

FIG. 27 shows a rear view of the entry exit hole.

FIG. 28 shows a close up of the entry exit hole shown in FIG. 27.

FIG. 29 shows additional placement location for entry or exit holes in a mask.

FIG. 30 shows possible placement locations for an entry or exit hole in a respirator.

FIG. 31 shows a rear view of a self-attaching pouch.

FIG. 32 shows a rear view of a self-attaching pouch attached to the mask or respirator.

FIG. 33 shows a block diagram for the signal path from a wired microphone.

FIG. 34 shows a block diagram for the signal path from a wireless microphone.

FIG. 35 shows a block diagram for the signal path from a wireless microphone with multiple receiving paths.

### DETAILED DESCRIPTION OF THE PREFERRED EMBODIMENTS

Embodiments of the present disclosure will be described below. The same or corresponding elements use the same reference numbers and description thereof may not be repeated.

When the number or an amount is mentioned in an embodiment described below, the scope of the present disclosure is not necessarily limited to the number or the amount unless otherwise specified. In the embodiment below, each component is not necessarily essential in the present disclosure unless otherwise specified. Combination of matters described in different embodiments are also possible.

While all the embodiments which show ways to secure the microphone or device to the inside or face side of the mask can also be shown and used on the outside of the masks or a combination of both inside and outside sides of the mask

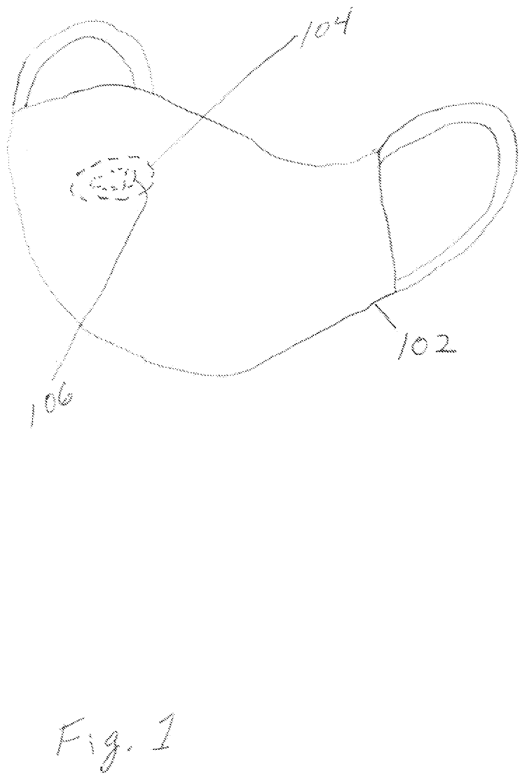

FIG. 1 is a front view of a mask according to an embodiment of the present invention. As shown in FIG. 1 a mask 102, contains a microphone or device 106, and a means to attach said microphone or device to the mask 104.

Mask 102 may be a disposable mask that is disposed of after it is used once or may be a reusable mask suitable for repeated use.

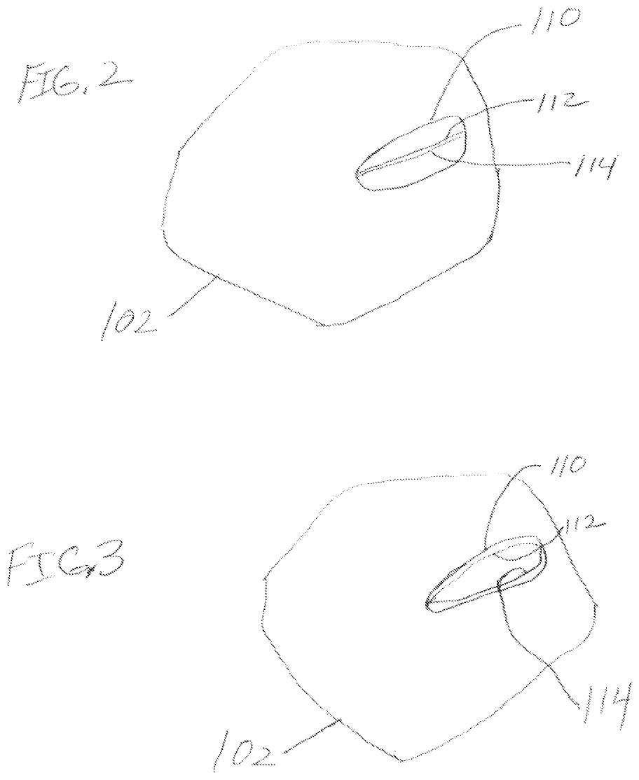

FIG. 2 shows a rear view of a mask 102 containing a pouch 110. Said pouch contains at least 2 lips 112 and 114 that can be opened for insertion and removal of a microphone or device. Pouch and lips are shown in the closed position.

FIG. 3 shows the mask 102, the pouch 110 and the lips 112 and 114 in the open position.

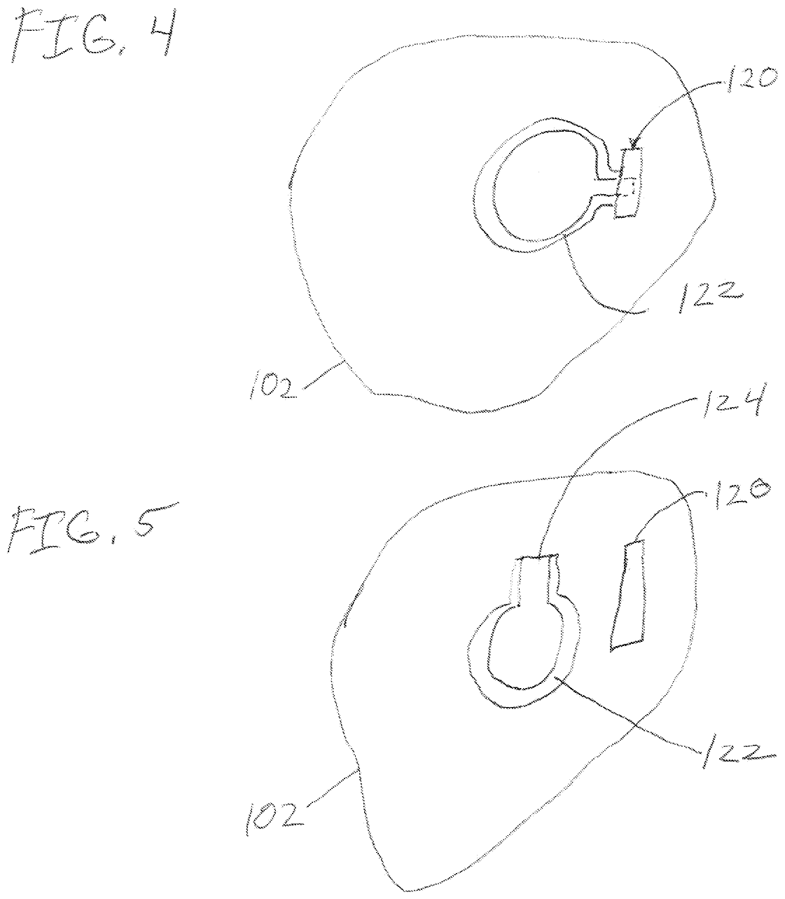

FIG. 4 shows a rear view of a mask 102 with another embodiment of the invention. The microphone or device is attached to the mask by a pouch 122 that contains a flap 124 which is inserted into a flap receptacle 120.

FIG. 5 shows the mask 102, and pouch 122 with flap 124, in FIG. 4 in the open position.

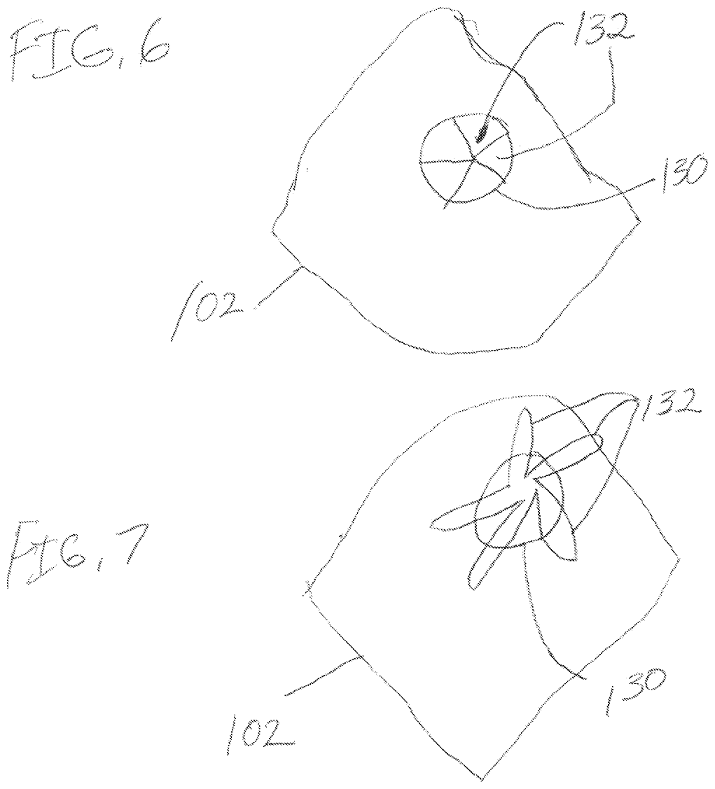

FIG. 6 shows a rear view of the mask 102 with a pouch 130 that uses a multitude of fingers 132 to secure the microphone or device.

FIG. 7 shows a rear view of the mask 102 with a pouch 130 and fingers 132 shown in FIG. 6 in the open position.

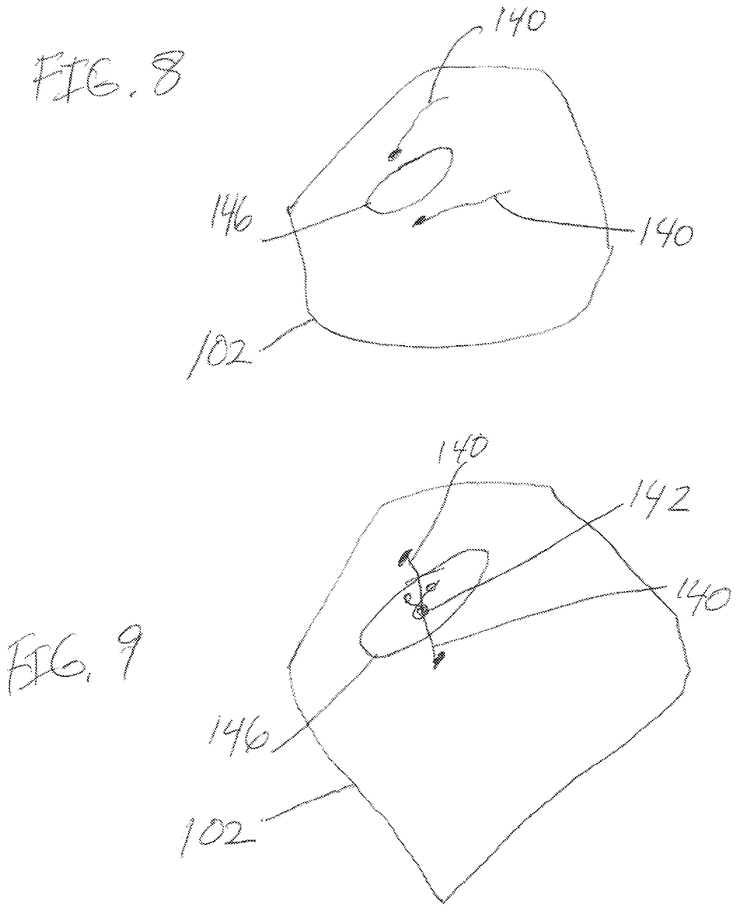

FIG. 8 shows a rear view of the mask 102 with yet another embodiment of the invention. In this case the microphone or device is secured into the pouch 146 by one or more filaments 140.

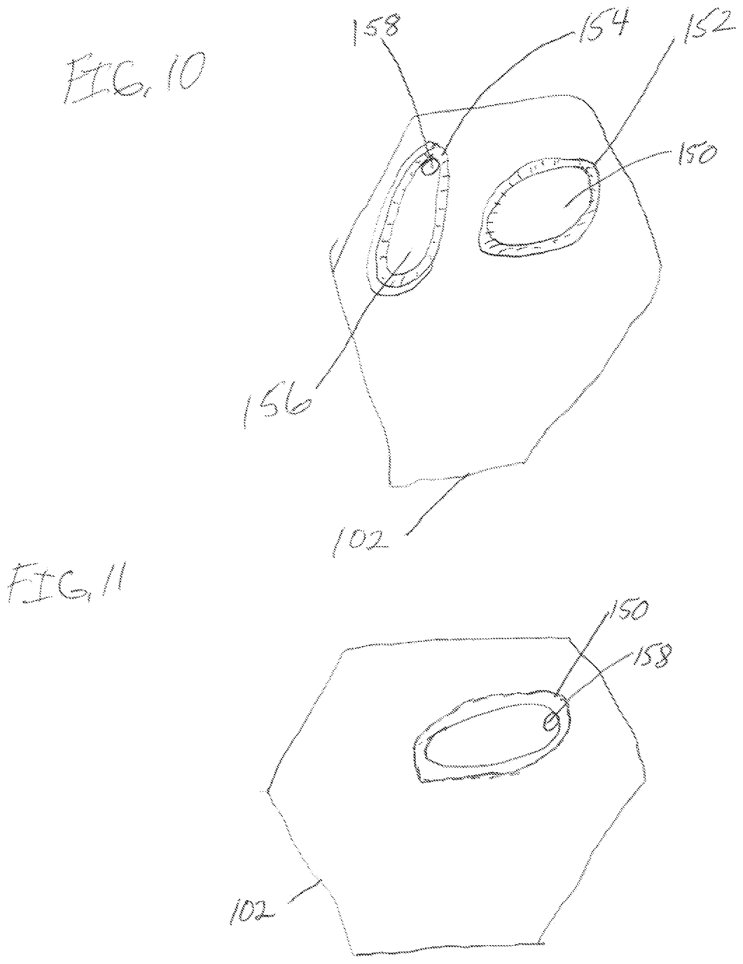

FIG. 9 shows the embodiment in FIG. 8 in the closed position. Filaments 140 are secured together 142 to lock the microphone or device into the pouch 146.

FIG. 10 shows a rear view of the mask 102 with yet another embodiment of the invention comprising a pouch 150 built into the mask, a pouch cover 156 which attaches to said pouch by means of two pieces of material that stick together when in contact with each other. One piece of the material 152 is on said pouch 150 and one piece of the material 154 is around the edge of said pouch cover 156. Pouch 150 contains a hole 158 to allow wire or tube entry or exit to the microphone or device in the pouch.

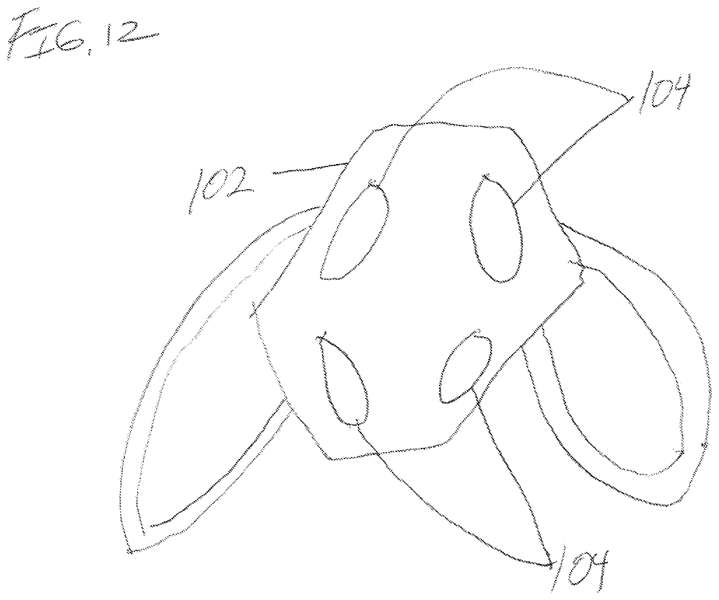

FIG. 11 shows the rear view of the mask 102 with the embodiment of the invention in FIG. 10 in the closed position.

FIG. 12 shows a rear view of the mask 102 with many but not all of the possible positions for any of the pouches 104 or attachment devices to be placed on the mask.

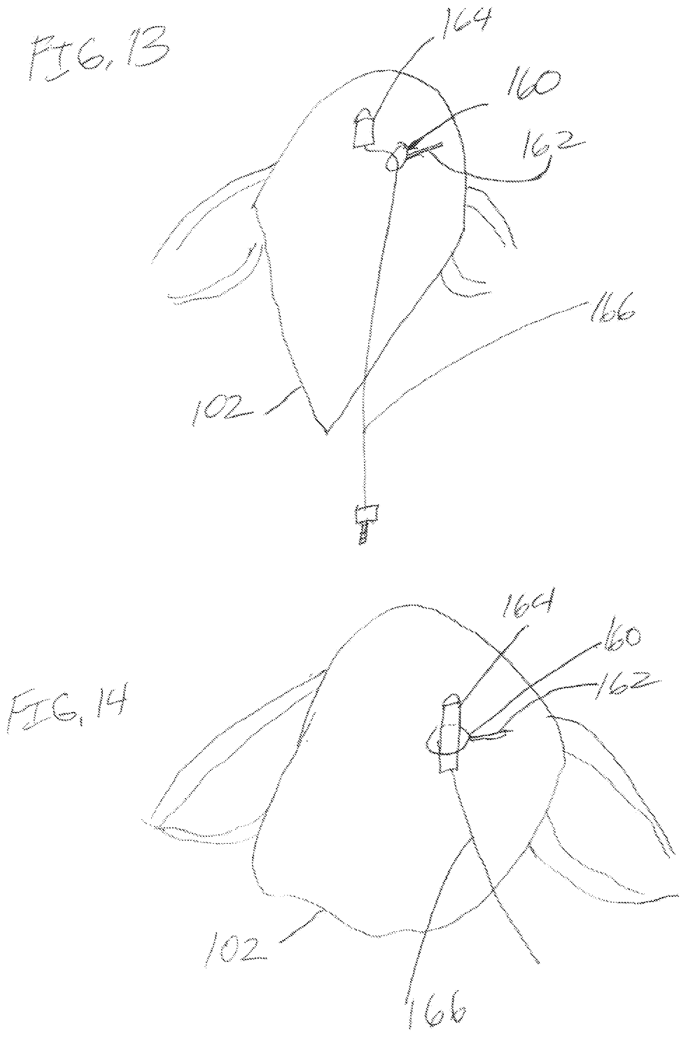

FIG. 13 shows a rear view of the mask 102 in yet another possible embodiment of the invention securing a microphone or device 164 to the mask using a loop of material 160 attached to the mask or respirator. The loop may be directly attached to the mask or off from the mask by using an additional filament 162. Further the microphone or device may be secured by securing the wire or tube 166 from the microphone or device.

FIG. 14 shows the embodiment in FIG. 13 securing said microphone or device 164 directly on the body of said microphone or device 164.

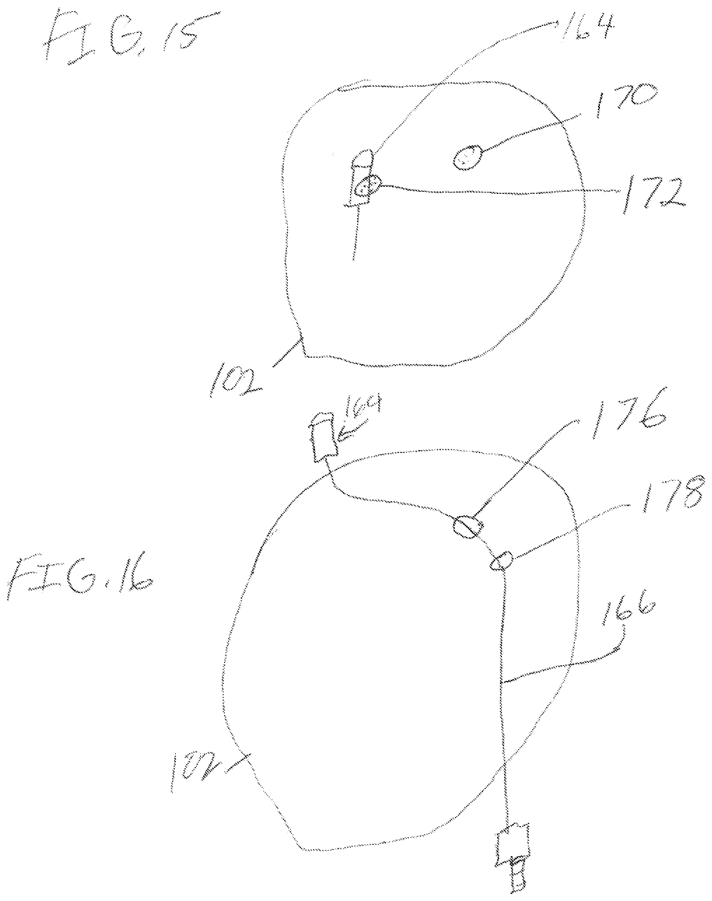

FIG. 15 shows yet another embodiment of the invention with a means of securing a microphone or device 164 directly to the mask by means of two pieces of material that stick together when in contact with each other. One piece of the material 170 is attached to said mask 102 and one piece of the material 172 is attached to said microphone or device 164.

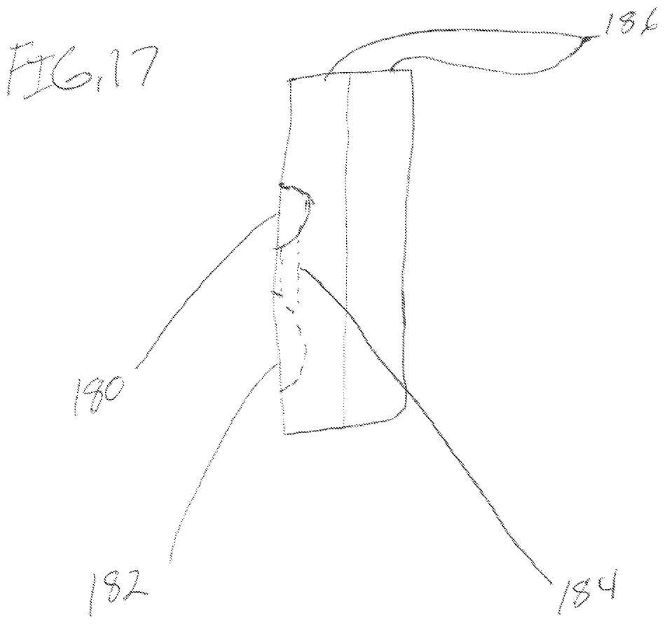

FIG. 16 shows a rear view of the mask 102 in yet another embodiment of the invention. The microphone or device 164 is secured to the mask using one or more holes 176 and 178. These holes are in one or more layers in the mask but do not pierce all of the layers to insure the mask remains sealed. The microphone or device 164 can be directly inserted into the holes or the wire or tube from the microphone or device 166 can be strung through the hole or holes.

FIG. 17 shows a partially exploded perspective view of the holes in the mask in the embodiment in FIG. 16. The mask can be made of one or more layers 186. In order to preserve the function of the mask the holes should not go all the way through all the layers. If the mask has only one layer than the holes should only be partially though that layer. The microphone or device can be inserted directly into the holes into space 184 or the microphone or device may be secured by running the wire or tube into the hole 180, through space 184 and out of hole 182. The order one runs the wire through the holes may be reversed if so desired.

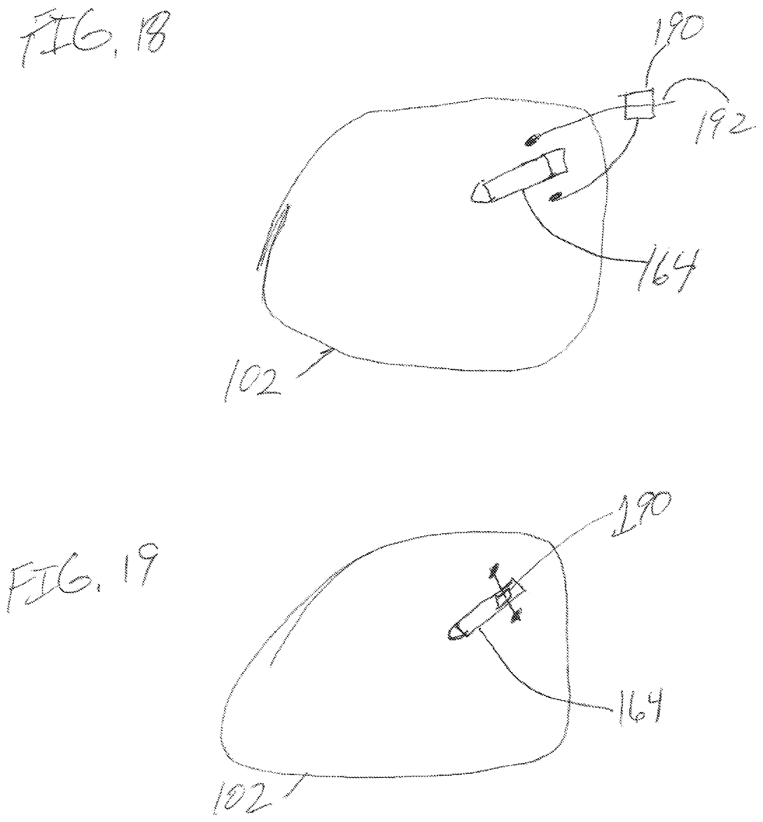

FIG. 18 shows a rear view of the mask 102 in yet another embodiment of the invention where the microphone or device 164 is secured using two strips of material where one strip includes a fastening mechanism 190 and one strip 192 is inserted into said fastening mechanism 190.

FIG. 19 shows the rear view of the mask 102 embodiment in FIG. 18 in the secured position with fastening mechanism 190 tight against the microphone or device 164.

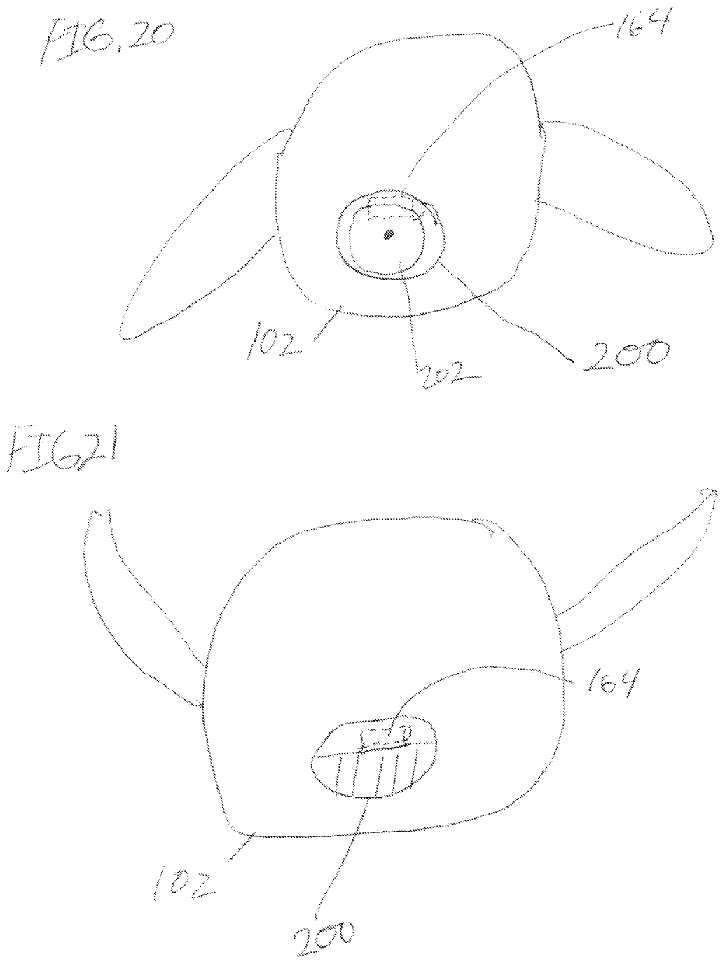

FIG. 20 shows a rear view of the mask 102 where the microphone 164 is secured into a vent 200 on the mask. Often vents have a material cover 202. Microphone or device can be secured behind the material cover 202 or built into the vent 200.

FIG. 21 shows a front view of the vent 200 with microphone 164 placed inside said vent.

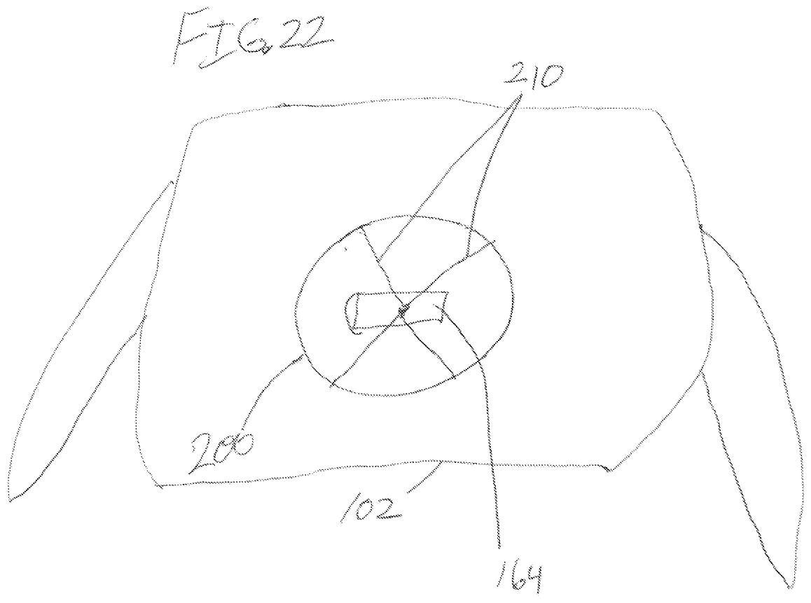

FIG. 22 shows a rear view of mask 102 in yet another embodiment of the invention where the microphone or device 164 is placed in the vent 200 secured by filaments 210. Filaments can be made of elastic material.

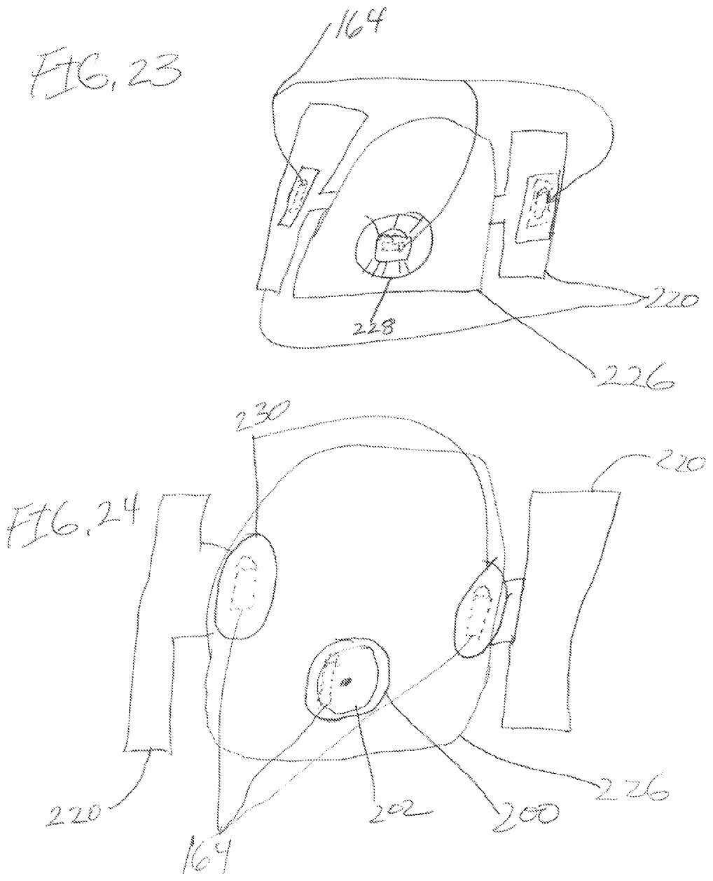

FIG. 23 shows a front view of possible placement locations of a microphone or device 164 in a respirator 226. Placement in a one or both filters 220, mask vent 228, or a combination of placement in the filters and vents.

FIG. 24 shows a rear view a respirator of the embodiment in FIG. 23.

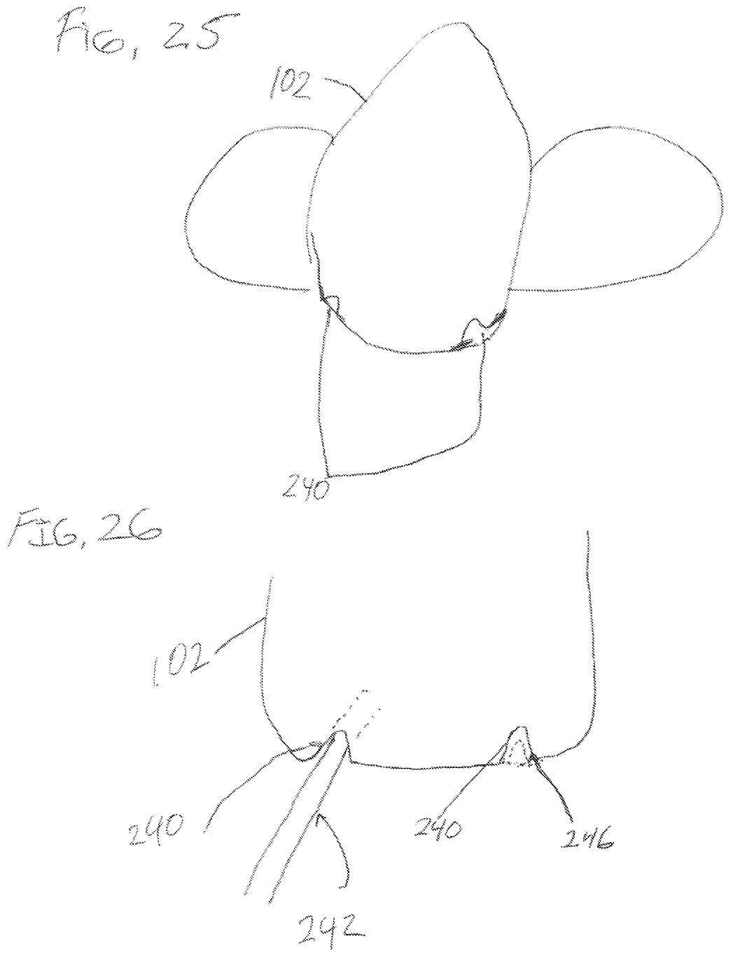

FIG. 25 shows a rear view of the mask 102 edge loops 240. The edge loops can also be used on a respirator.

FIG. 26 shows a close up view of the edge loops in FIG. 25. Each edge loop 240 is lined with a filler material 246 that fills the gap between the edge loop and anything coming through the edge loop such as a microphone wire or tube from a device 242. The filler material 246 ensures that the seal of the mask is maintained.

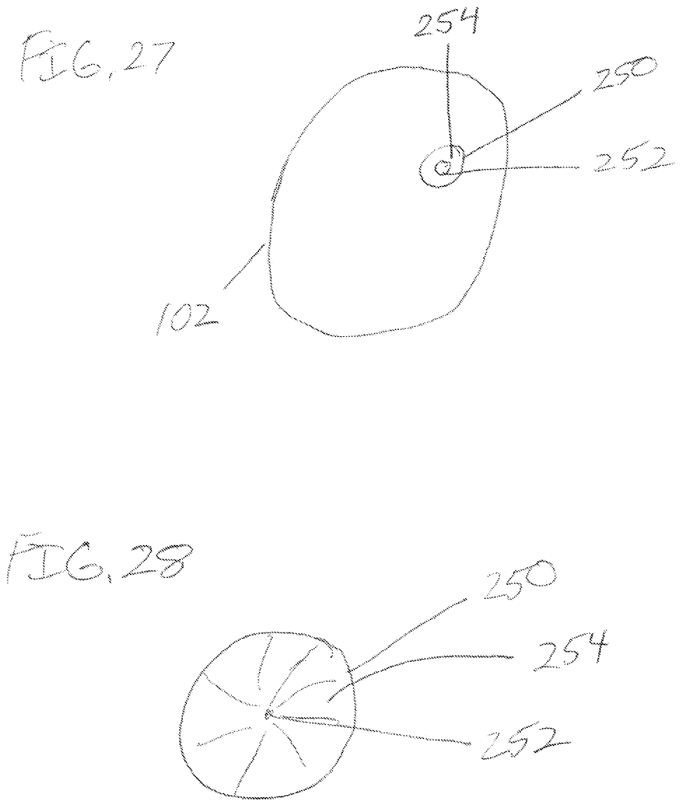

FIG. 27 shows a rear view of the mask 102 in an additional embodiment of the invention. Comprising a hole 250 to allow a wire, tube, or other device 252 to enter or exit the mask. A filler material 254 fills the space between the hole 250 and the wire, tube or other device 252, completely sealing the mask.

FIG. 28 shows a close up view of the entry or exit hole 250 shown in FIG. 27. Filler material 254 seals any gap between the entry or exit hole 250 and the wire, tube or other device 252.

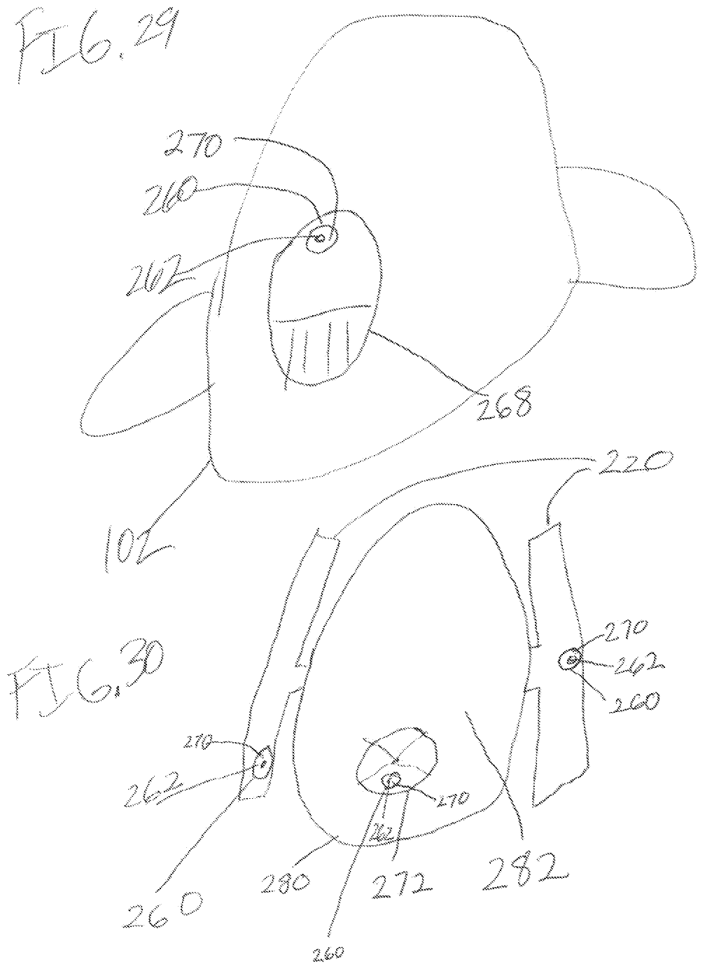

FIG. 29 shows an additional possible location for the entry or exit hole 260 in a mask 102 placing said hole in a vent 268. Filler material 270 seals between the entry or exit hole 260 and the wire, tube or other device 262.

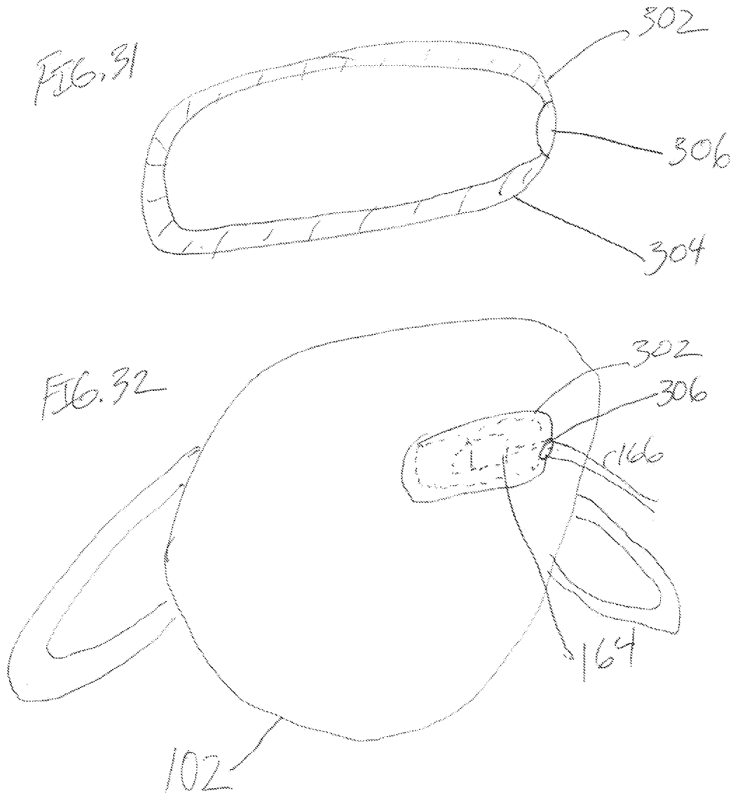

FIG. 30 shows a rear view of possible placements for an entry or exit hole 260 in a respirator 280. The entry or exit hole can be placed in the one or both filters 220 or vent 272 or anywhere in the respirator body 282.

FIG. 31 shows a rear view of a self-sticking pouch 302. A sticky substance 304 allows the pouch to attach to any mask or respirator. A hole 306 allows a microphone wire, tube or other device to enter or exit the pouch. Additionally, double sided tape can be attached to the pouch in place of the sticky substance for another way to attach the self-sticking pouch to the mask or respirator.

FIG. 32 shows a rear view of a self-attaching pouch 302 attached to a mask or respirator 102. Securing microphone or device 164. An entry or exit hole 306 allows a microphone wire, tube, or other device 166 to enter or exit the self-attaching pouch.

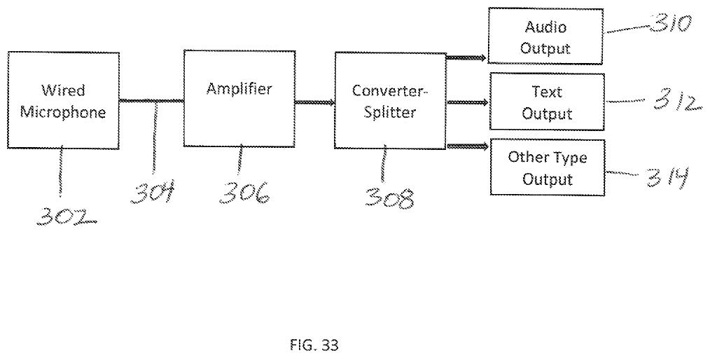

FIG. 33 shows a block diagram of the signal path from a wired microphone. The signal path is comprised of a wired microphone 302, a microphone wire 304, an amplifier 306, a converter-splitter 308 which takes the audio signal and outputs one or more of the following; audio, text, and other type outputs to one or more output devices; audio output 310, text output 312, other type output 314.

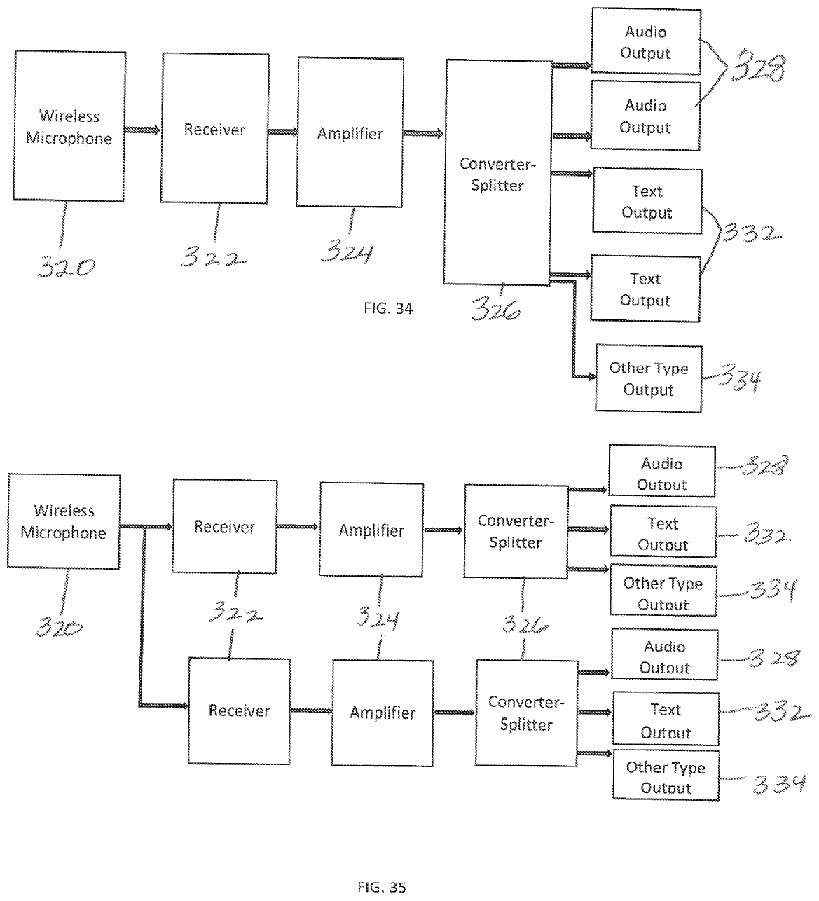

FIG. 34 shows a block diagram of the signal path from a wireless microphone. The signal path is comprised of a wireless microphone 320, a receivers 322, an amplifiers 324, a converter-splitters 326 which takes the audio signal and outputs one or more of the following; audio, text, and other type outputs to one or more output devices; audio output 328, text output 332, other type output 334.

FIG. 35 shows a block diagram of the signal path from a wireless microphone comprising a wireless microphone 320, a multitude of receivers 322, amplifiers 324, converter-splitters 326 and audio outputs 328, text outputs 332, and other type outputs 334. This configuration allows for a multitude of listeners or devices receiving the signal from the microphone either in audio, text or other type outputs.

While various embodiments have been described above, it should be understood that they have been presented by way of example only, and not limitation. Thus, the breadth and scope of the preferred embodiment should not be limited by any of the above described exemplary embodiments, but should be defined only in accordance with the following claims and their equivalents.

What is claimed is:

1. A mask or respirator that fits over a user's mouth and nose, comprising:
a material covering the user's nose and mouth
a means to incorporate a microphone

2. A mask or respirator recited in claim 1, where the means of incorporating a microphone is a pouch attached to the mask.

3. A mask or respirator recited in claim 1, where the means of incorporating a microphone is a pouch built into the mask.

4. A mask or respirator recited in claim 1, where a microphone is attached to the mask.

5. A mask or respirator recited in claim 1. Where the mask contains a vent that a microphone is placed inside said vent.

6. A mask or respirator recited in claim 1. Where the mask contains a filter that a microphone is placed inside said filter.

7. A mask or respirator recited in claim 1, where the means of incorporating the microphone is connecting the microphone to the mask using two strips of material where one strip includes a fastening mechanism.

8. A mask or respirator recited in claim 1, where the means of incorporating the microphone is attaching the microphone to the mask using two pieces of fabric that stick together when in contact with each other.

9. A mask or respirator recited in claim 1, where the means of attaching a microphone to the mask is a sticky substance.

10. A mask or respirator recited in claim 3, with a means for containing the microphone within said pouch.

11. A mask or respirator recited in claim 2, where said pouch has a hole in it.

12. A stand-alone pouch with a means for attachment to a mask or respirator, comprising.
a pouch made out of material
a means to attach said pouch to a mask or respirator

13. A stand-alone pouch recited in claim 12, where the means for attaching to the mask or respirator is a sticky substance.

14. A stand-alone pouch recited in claim 12, where the means for attaching to the mask or respirator are two pieces of fabric that stick together when in contact with each other.

15. A stand-alone pouch recited in claim 12, where the pouch has a hole in it.

16. A mask or respirator, and a means for getting a wire or tube in or out of the mask comprising:
a material covering the user's nose and mouth
a hole in said material

17. A mask or respirator recited in claim 16, where the mask or respirator contains other components and the hole is placed in one of said components.

18. A mask or respirator recited in claim 16, where the hole is sealed by lining the hole with a material.

19. A mask or respirator recited in claim 1 containing a microphone with a means for converting the signal from the microphone to text.

20. A mask or respirator recited in claim 19 that has a means of sending either the converted text or the original audio signal or both to more than one destination.
